(19) United States
(12) Patent Application Publication
(10) Pub. No.: US 2016/0228853 A1
(43) Pub. Date: Aug. 11, 2016

(54) CATALYST MATERIAL FOR EXHAUST GAS PURIFICATION AND METHOD FOR PRODUCING SAME

(71) Applicant: MAZDA MOTOR CORPORATION, Hiroshima (JP)

(72) Inventors: Yasuhiro MATSUMURA, Hiroshima-shi, Hiroshima (JP); Masahiko SHIGETSU, Higashihiroshima-shi, Hiroshima (JP); Hisaya KAWABATA, Hiroshima-shi, Hiroshima (JP); Yuki KODA, Hiroshima-shi, Hiroshima (JP)

(73) Assignee: MAZDA MOTOR CORPORATION, Hiroshima (JP)

(21) Appl. No.: 15/022,956

(22) PCT Filed: Oct. 30, 2014
(86) PCT No.: PCT/JP2014/005508

§ 371 Date: Mar. 18, 2016

(30) Foreign Application Priority Data
Nov. 20, 2013 (JP) 2013-240160
Nov. 20, 2013 (JP) 2013-240161

(51) Int. Cl. B01J 23/63; B01D 53/94; B01J 37/08; B01J 37/03; B01J 23/00; B01J 37/16

(52) U.S. Cl. CPC B01J 23/63; B01J 23/002; B01J 37/16; B01J 37/08; B01J 37/031; B01D 53/945; B01J 2523/00; B01D 2255/1025; B01D 2255/2061; B01D 2255/2063; B01D 2255/2065; B01D 2255/2068; B01D 2255/20715

(57) ABSTRACT

An exhaust gas purification catalytic material is made of a composite oxide. This composite oxide contains Zr and a plurality of rare earth metals, and is doped with Rh. An surface portion of the composite oxide has a higher concentration of at least one of the rare earth metals than an inner portion thereof.

### TECHNICAL FIELD

The present invention relates to an exhaust gas purification catalytic material and a method for producing the same.

### BACKGROUND ART

Three-way catalysts have been known as exhaust gas purification catalysts for automobiles. A catalytic material in which Rh is supported on a composite oxide has conventionally been used as the three-way catalyst. However, if a catalyst is exposed to a high-temperature exhaust gas for a long period of time, Rh may agglomerate to undergo sintering, which may degrade catalyst activity.

As an exhaust gas purification catalytic material to overcome this problem, Patent Document 1 describes a catalyst in which Rh is supported on a support made of an inorganic mixed oxide of Nd, Al, Ce, Zr, and La.

According to Patent Document 1, this catalyst is generally produced by the following method. A solution in which aluminium nitrate, cerium nitrate, zirconium oxynitrate, and lanthanum nitrate are dissolved in pure water is dropped into aqueous ammonia. A precipitate thus obtained is dried and calcined, thereby obtaining powder of secondary particles in which first particles made of La-containing CeO₂−ZrO₂ and second particles made of La-containing Al₂O₃ are mixed and agglomerated. This powder is mixed with neodymium nitrate dissolved in water. The resultant mixture is stirred, dried, and calcined, thereby obtaining inorganic mixed oxide powder in which Nd is segregated on surface layers of the first and second particles. This inorganic mixed oxide is immersed in an aqueous rhodium nitrate solution, and is calcined, thereby obtaining the catalyst.

Patent Document 2 describes a catalyst in which a precious metal is supported on an oxide support. Under an oxidizing atmosphere, the catalyst includes a surface oxide layer in which a precious metal in a high state of oxidation exists on the surface of the support and is bonded to cations in the support via oxygen on the support surface. Under a reducing atmosphere, a precious metal in a metallic state exists on the support surface, and the proportion of the precious metal exposed at the support surface in the total amount of the precious metal supported on the support is higher than or equal to 10% in terms of the atomic ratio.

In addition, Patent Document 2 describes a CeO₂—ZrO₂—Y₂O₃ composite oxide, a ZrO₂—La₂O₃ composite oxide, a CeO₂—ZrO₂ composite oxide, and a CeO₂—ZrO₂—La₂O₃—Pr₂O₃ composite oxide as examples of the oxide support, and further describes a process for producing a catalyst. In this process, deionized water containing a composite oxide is stirred. A mixed solution in which neodymium nitrate is added to the composite oxide stirred therein is subjected to evaporation to dryness. The resultant material is further dried and calcined. Then, the dried and calcined material is immersed in an aqueous rhodium nitrate solution. The material immersed therein is filtered and washed, and is then dried and calcined, thereby obtaining the catalyst.

Patent Document 3 describes a catalytic material in which the solid solubility of a precious metal in a crystal structure of a composite oxide consisting of zirconia, at least one coordinating element selected from the group consisting of a rare earth element, an alkaline earth element, aluminium, and silicon, and a precious metal is higher than or equal to 50%.

Patent Document 3 describes coprecipitation as an example of a process for producing the catalytic material. In this process, an aqueous mixed salt solution containing salt of Zr and salt of a coordinating element is added to a neutralizer and coprecipitated, thereby obtaining a coprecipitate. Then, this coprecipitate is dried, and is then subjected to a heat treatment (primary calcination). The resultant material is mixed with a solution containing salt of a precious metal, and a precursor composition obtained is subjected to a heat treatment (secondary calcination), thereby obtaining a heat-resistant oxide. Alternatively, a neutralizer may be added to an aqueous mixed salt solution containing salt of Zr, salt of a coordinating element, and salt of a precious metal, and the resultant material may be coprecipitated, thereby obtaining a precursor composition. The precursor composition may be dried, and may be then subjected to a heat treatment, thereby obtaining a heat-resistant oxide.

In Patent Document 3, examples of such a heat-resistant oxide include a ZrLaRh composite oxide, a ZrYRh composite oxide, a ZrNdRh composite oxide, a ZrLaNdRh composite oxide, a ZrLaSrRh composite oxide, and a ZrCeLaRh composite oxide.

### CITATION LIST

### Patent Document

PATENT DOCUMENT 1: Japanese Unexamined Patent Publication No. 2011-136319

PATENT DOCUMENT 2: Japanese Unexamined Patent Publication No. 2007-289920

PATENT DOCUMENT 3: Japanese Unexamined Patent Publication No. 2006-169035

### SUMMARY OF THE INVENTION

### Technical Problem

Patent Documents 1 and 2 show that in summary, after Nd is supported on the surface of a CeZr-based composite oxide, Rh is further supported thereon to allow Nd to restrain the movement of Rh. Patent Document 2 shows that Rh is further made metallic by a reduction treatment. Patent Document 3 shows that in summary, Rh is dissolved in a crystal structure of a Zr-based composite oxide by a heat treatment to reduce the grain growth of Rh during the use of a catalyst in a hot condition.

Unlike Patent Documents 1-3, the present invention is intended to reduce agglomeration and sintering of Rh (increase the high-temperature durability of a catalytic material) by improving the bonding force of Rh to a Zr-based composite oxide.

For example, in the case of a Rh-doped composite oxide in which a Zr-based composite oxide containing Ce is doped with Rh (Rh forms a composite oxide together with Ce and Zr, and is placed at crystal lattice points or between lattice points of the composite oxide), part of Rh is exposed at the surface of the composite oxide, and functions to purify an exhaust gas. However, if this part of Rh is exposed to a high-temperature exhaust gas and sintered, the degree of degradation in catalyst activity increases, because the amount of Rh exposed at the surface of the composite oxide is small A Rh-doped composite oxide that is devoid of Ce also has a similar problem.

The present invention is, therefore, intended to increase the high-temperature durability of an exhaust gas purification catalytic material made of the Rh-doped composite oxide described above, while improving the activity thereof.

### Solution to the Problem

To achieve the objective, the present invention allows for concentrating, in a surface portion of a Rh-doped composite oxide containing Zr and a plurality of rare earth metals, at least one of the rare earth metals.

Specifically, an exhaust gas purification catalytic material according to the present invention is made of a composite oxide containing Zr and a plurality of rare earth metals and doped with Rh. A surface portion of the composite oxide has a higher concentration of at least one of the rare earth metals than an inner portion of the composite oxide.

Here, a situation where the surface portion of the composite oxide has a higher concentration of at least one of the rare earth metals than the inner portion of the composite oxide includes a situation where the rare earth metal exists in the surface portion of the composite oxide, and the inner portion of the composite oxide is substantially devoid of the rare earth metal. In addition, a situation where the surface portion of the composite oxide has a high concentration of the rare earth metal includes a situation where a large amount of the rare earth metal is dissolved in the surface portion of the composite oxide, and at least part (a small amount) of this rare earth metal exists, as an oxide, on the surface of the composite oxide.

In such a catalyst, Rh with which the composite oxide is doped is allowed to be dispersed to be firmly immobilized by the rare earth metal contained in the surface portion of the composite oxide at a high concentration. This improves the activity of the catalyst, and improves the high-temperature durability thereof. As a result, if the catalyst continues being used while being exposed to a high-temperature exhaust gas, the activity of the catalyst is prevented from significantly decreasing.

In a preferred embodiment, the composite oxide contains at least Ce and Nd as the rare earth metals, and the surface portion of the composite oxide has a higher concentration of the Nd than the inner portion of the composite oxide.

According to this embodiment, Rh with which the composite oxide is doped is dispersed while being firmly immobilized by Nd contained in the surface portion of the composite oxide at a high concentration. In this embodiment, it is preferable that the composite oxide further contains La and Y as the rare earth metals.

In another preferred embodiment, the composite oxide contains at least La and Y as the rare earth metals, and is devoid of Ce, and the surface portion of the composite oxide has a higher concentration of at least one of the La or the Y than the inner portion of the composite oxide. According to this embodiment, Rh with which the composite oxide is doped is dispersed while being firmly immobilized by La and/or Y contained in the surface portion of the composite oxide at a high concentration.

The Rh-doped composite oxide preferably has been subjected to a heating and reducing treatment. This heating and reducing treatment promotes metallization of Rh (making Rh metallic), and improves the activity of the catalyst. In addition, the heating and reducing treatment promotes the precipitation of Rh buried in the composite oxide on the composite oxide surface portion, and Rh is allowed to be dispersed to be firmly immobilized by the rare earth metal contained in the surface portion of the composite oxide at a high concentration. This helps improve the activity and high-temperature durability of the catalyst.

A preferable method for producing an exhaust gas purification catalytic material containing at least Ce and Nd as the rare earth metals includes steps of:

coprecipitating Ce, Zr, and Rh by adding a basic solution to an acidic solution containing Ce ions, Zr ions, and Rh ions;

adding a basic solution to a RhCeZr-containing coprecipitated gel formed by the coprecipitation;

adding an acidic solution containing Rh ions and Nd ions to the RhCeZr-containing coprecipitated gel to which the basic solution has been added, and mixing them; and

calcining a precursor which is the RhCeZr-containing coprecipitated gel having a Rh hydroxide and a Nd hydroxide precipitated thereon through the mixing.

Here, the acidic solution for forming the coprecipitated gel may contain Nd ions.

The production method provides a Rh-doped composite oxide containing Ce, Zr, Nd, and Rh and containing Nd and Rh in its surface portion at high concentrations. This helps improve the activity and high-temperature durability of the catalyst.

The calcined precursor is preferably heated in a reducing atmosphere. This promotes the metallization of Rh (making Rh metallic), and improves the activity of the catalyst. In addition, the heating and reducing treatment promotes the precipitation of Rh buried in the composite oxide on the composite oxide surface portion, and Rh is allowed to be dispersed to be firmly immobilized by the rare earth metal contained in the surface portion of the composite oxide at a high concentration. This helps improve the activity and high-temperature durability of the catalyst.

A preferable method for producing an exhaust gas purification catalytic material that contains at least La and Y and is devoid of Ce includes steps of:

coprecipitating Zr, La, Y, and Rh by adding a basic solution to an acidic solution that contains Zr ions, La ions, Y ions, and Rh ions and is devoid of Ce;

adding a basic solution to a RhZrLaY-containing coprecipitated gel formed by the coprecipitation;

adding an acidic solution containing La or Y ions and Rh ions to the RhZrLaY-containing coprecipitated gel to which the basic solution has been added, and mixing them; and

calcining a precursor which is the RhZrLaY-containing coprecipitated gel having a La or Y hydroxide and a Rh hydroxide precipitated thereon through the mixing.

The production method provides a composite oxide containing Zr, La, Y, and Rh and containing La or Y and Rh in its surface portion at high concentrations. This helps improve the activity and high-temperature durability of the catalyst.

Heating is preferably performed in a reducing atmosphere after the calcination. This promotes the metallization of Rh (making Rh metallic), and improves the activity of the catalyst. In addition, the heating reducing treatment promotes the precipitation of Rh buried in the composite oxide on the composite oxide surface portion, and Rh is allowed to be dispersed to be firmly immobilized on the composite oxide surface portion by La or Y. This helps improve the activity and high-temperature durability of the catalyst.

### Advantages of the Invention

According to the present invention, a surface portion of a Rh-doped composite oxide containing Zr and a plurality of rare earth metals has a higher concentration of at least one of the rare earth metals than an inner portion thereof. This improves the activity and high-temperature durability of a catalyst.

### BRIEF DESCRIPTION OF THE DRAWINGS

FIG. 1 schematically shows a Rh-doped composite oxide according to a first embodiment of the present invention.

FIG. 2 schematically shows a state in which Rh in the same form is bonded to Nd in a composite oxide via oxygen.

FIG. 3 is a block diagram showing process steps for producing a Rh-doped composite oxide according to a first example.

FIG. 4 is a graph showing the specific surface area of a Rh-doped composite oxide according to each of the first example, a second example, and a comparative example and the degree of dispersion of Rh on the surface of the Rh-doped composite oxide.

FIG. 5 is a graph showing light-off temperatures of the first and second examples and the comparative example.

FIG. 6 is a graph showing high-temperature purification efficiencies of the first and second examples and the comparative example.

FIG. 7 is a graph showing the relationship between catalyst inlet gas temperatures and HC purification efficiencies of the first and second examples and the comparative example.

FIG. 8 is a graph showing light-off temperatures of the first example, a third example, and the comparative example.

FIG. 9 is a graph showing light-off temperatures of the first and second examples, fourth and fifth examples, and the comparative example.

FIG. 10 schematically shows a Rh-doped composite oxide according to a second embodiment of the present invention.

FIG. 11 schematically shows a state in which Rh in the same form is bonded to La or Y in a composite oxide via oxygen.

FIG. 12 is a block diagram showing process steps for producing a Rh-doped composite oxide according to a sixth example.

FIG. 13 is a block diagram showing process steps for producing a Rh-doped composite oxide according to a seventh example.

FIG. 14 is a graph showing light-off temperatures of the sixth and seventh examples and a comparative example.

FIG. 15 is a graph showing high-temperature purification efficiencies of the sixth and seventh examples and the comparative example.

FIG. 16 is a graph showing light-off temperatures of eighth and ninth examples and the comparative example.

FIG. 17 is a graph showing high-temperature purification efficiencies of the eighth and ninth examples and the comparative example.

FIG. 18 is a graph showing NOₓ purification efficiencies of the sixth and seventh examples, tenth and eleventh examples, and the comparative example.

FIG. 19 is a block diagram showing process steps for producing a Rh-doped composite oxide according to a twelfth example.

### DESCRIPTION OF EMBODIMENTS

Embodiments of the present invention will now be described with reference to the drawings. Note that the following description of preferred embodiments is merely illustrative in nature, and is not intended to limit the scope, applications, and use of the present invention.

### First Embodiment

### Configuration of Exhaust Gas Purification Catalytic Material

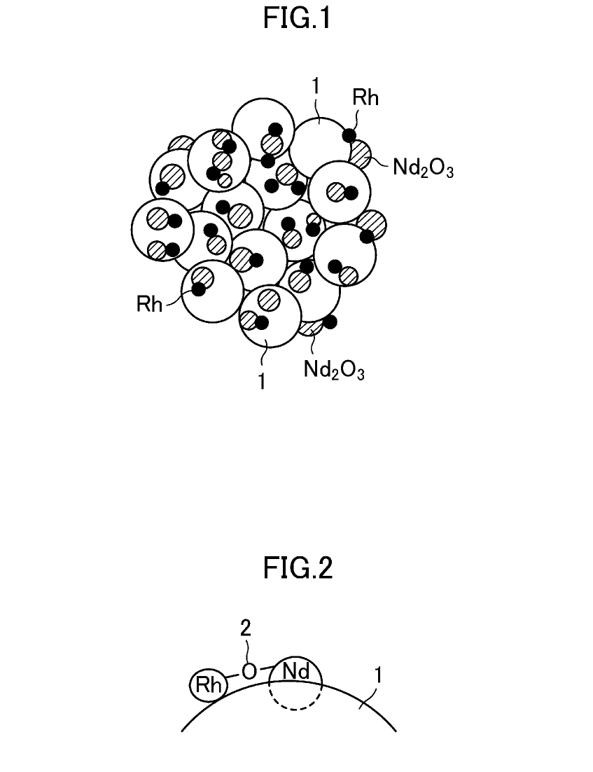

An exhaust gas purification catalytic material according to this embodiment is suitable for purifying an exhaust gas from an automobile, and is made of Rh-doped composite oxide particles 1 schematically shown in FIG. 1. These Rh-doped composite oxide particles 1 are obtained by doping, with Rh, a composite oxide containing Ce, Zr, and at least Nd as a rare earth metal except Ce. Nd exists in the form of Nd₂O₃ forming part of the composite oxide, and a surface portion of each particle 1 has a higher Nd concentration than an inner portion thereof. Specifically, at least part of Nd is dissolved in the surface portion of the composite oxide, and a small amount of Nd further exists, as an oxide, on the surface of the composite oxide, thereby allowing the particle surface portion to have a higher Nd concentration than the particle inner portion. Rh is placed at crystal lattice points or between lattice points of the composite oxide, and is partially exposed at the surfaces of the particles 1. Thus, the surface portion of each particle 1 has a higher Rh concentration than the inner portion of the particle. As shown in FIG. 2, the Rh exposed at the surfaces of the particles 1 is firmly bonded, via oxygen 2, to Nd of Nd₂O₃ which exists in the surface portion and forms part of the composite oxide.

### Examples and Comparative Example of Exhaust Gas Purification Catalyst

### First Example

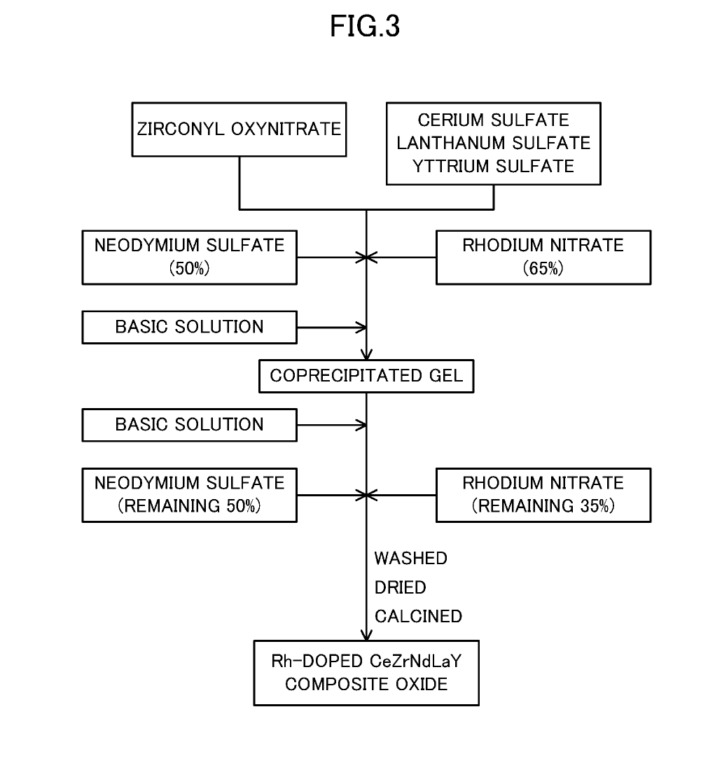

As shown in FIG. 3, an aqueous solution containing cerium sulfate, neodymium sulfate, lanthanum sulfate, and yttrium sulfate, and an aqueous zirconyl oxynitrate solution were mixed, and an aqueous rhodium nitrate solution was further added to the mixture. The amount of an aqueous neodymium sulfate solution prepared in this stage was set to be 50% of the target amount of neodymium sulfate added (the total amount of the aqueous neodymium sulfate solution intended to form part of a Rh-doped composite oxide). The character “%” represents “% by mass.” This also applies to the rest of the description. In addition, the amount of the aqueous rhodium nitrate solution prepared in this stage was 65% of the target amount of rhodium nitrate added.

A basic solution (aqueous ammonia) was added to the resultant mixed solution (acid) of Ce, Zr, Nd, La, Y, and Rh, thereby coprecipitating Ce, Zr, Nd, La, Y, and Rh. A basic solution was added to the resultant RhCeZrNdLaY-containing coprecipitated gel so that the resultant mixture had a pH of about 11. Then, the remaining aqueous neodymium sulfate solution (50%) and the remaining aqueous rhodium nitrate solution (35%) were added to the mixture and mixed. In this manner, a Rh hydroxide and a Nd hydroxide were precipitated on particles of the coprecipitated gel. A precipitate thus obtained was entirely washed and dried in the air at 150° C. for 24 hours. The dried precipitate was pulverized, and then calcined in the air at 520° C. for two hours. In this manner, a Rh-doped composite oxide (a Rh-doped CeZrNdLaY composite oxide) that is a target substance was obtained.

The composition of the Rh-doped composite oxide except Rh is CeO₂:ZrO₂: Nd₂O₃:La₂O₃:Y₂O₃=10:75:5:5:5 (mass ratio). The total Rh-doping amount is 1% by mass of the CeZrNdLaY composite oxide.

The method for preparing the Rh-doped composite oxide is characterized in that the amounts of neodymium sulfate and rhodium nitrate prepared for coprecipitation were respectively 50% and 65%, and the remaining neodymium sulfate and the remaining rhodium nitrate were added to the coprecipitated gel.

Since part of neodymium sulfate (50%) was added to the coprecipitated gel, a surface portion of the resultant Rh-doped composite oxide had a higher Nd concentration than an inner portion thereof. XRD observation of the composite oxide showed no Nd peak. This result means that Nd had been dissolved in the surface portion of the composite oxide. It is recognized that no peak was observed, because the amount of a Nd oxide fixed on the surface of the composite oxide was small. The surface portion of the resultant Rh-doped composite oxide had a higher Rh concentration than the inner portion thereof, because part of rhodium nitrate (35%) was added to the coprecipitated gel.

Then, the Rh-doped composite oxide was mixed with a binder and water to form slurry, with which a honeycomb support was coated. The coated honeycomb support was calcined in the air at 500° C. for two hours, thereby obtaining a catalyst according to a first example. As the support, a cordierite honeycomb support (with a capacity of 100 mL) having a cell wall thickness of 3.5 mil (8.89×10⁻² mm) and including 600 cells per one square inch (645.16 mm²) was employed. The amount of the Rh-doped composite oxide supported per 1 L of the support was 100 g.

### Second Example

Unlike the first example, a RhCeZrLaY-containing coprecipitated gel was obtained with the amount of neodymium sulfate prepared for coprecipitation set to be 0%, and a target amount of neodymium sulfate added (100%) was entirely added to this coprecipitated gel. On the other hand, just like the first example, the amount of rhodium nitrate prepared for coprecipitation was 65% of the target amount of rhodium nitrate added, and the remaining rhodium nitrate, i.e., 35% of the target amount thereof, was added to the coprecipitated gel. As for the rest, a Rh-doped composite oxide that is a target substance was obtained just like the first example. The composition of the resultant Rh-doped composite oxide except Rh and the Rh-doping amount were the same as those of the first example. A honeycomb support similar to that in the first example was coated with this Rh-doped composite oxide in a similar manner, thereby obtaining a catalyst according to a second example. The amount of the Rh-doped composite oxide supported on the honeycomb support was 100 g/L just like the first example.

Since, also in the second example, a target amount of neodymium sulfate was entirely added to the coprecipitated gel, a surface portion of the resultant Rh-doped composite oxide had a higher Nd concentration than an inner portion thereof. Just like the first example, the surface portion of the resultant Rh-doped composite oxide further had a higher Rh concentration than the inner portion thereof.

### Third Example

Just like the first example, the amount of neodymium sulfate prepared for coprecipitation was 50%, and the remaining neodymium sulfate (50%) was added to a coprecipitated gel. However, unlike the first example, the amount of rhodium nitrate prepared for precipitation was 20%, and the remaining rhodium nitrate (80%) was added to the coprecipitated gel. Then, as for the rest, a Rh-doped CeZrNdLaY composite oxide that is a target substance was obtained in a manner similar to that in the first example. The composition of the Rh-doped composite oxide except Rh and the Rh-doping amount were the same as those of the first example. A honeycomb support similar to that in the first example was coated with this Rh-doped composite oxide in a similar manner, thereby obtaining a catalyst according to a third example. The amount of the Rh-doped composite oxide supported on the honeycomb support was 100 g/L just like the first example.

Since, also in the third example, part of neodymium sulfate (50%) was added to the coprecipitated gel, a surface portion of the resultant Rh-doped composite oxide had a higher Nd concentration than an inner portion thereof. Just like the first example, the surface portion of the resultant Rh-doped composite oxide further had a higher Rh concentration than the inner portion thereof.

### First Comparative Example

A target amount of neodymium sulfate was entirely prepared for coprecipitation, and the amount of neodymium sulfate added to a coprecipitated gel was zero. Just like the first example, the amount of rhodium nitrate prepared for coprecipitation was 65% of the target amount of rhodium nitrate added, and the remaining rhodium nitrate (35%) was added to the coprecipitated gel. Then, as for the rest, a Rh-doped CeZrNdLaY composite oxide that is a target substance was obtained in a manner similar to that in the first example. The composition of the resultant Rh-doped composite oxide except Rh and the Rh-doping amount were the same as those of the first example. A honeycomb support similar to that in the first example was coated with this Rh-doped composite oxide in a similar manner, thereby obtaining a catalyst according to a first comparative example. The amount of the Rh-doped composite oxide supported on the honeycomb support was 100 g/L just like the first example.

Since, in the first comparative example, a target amount of neodymium sulfate was entirely prepared for coprecipitation, it was recognized that the Nd concentration in the resultant Rh-doped composite oxide was substantially uniform all over the composite oxide. Just like the first example, an inner portion of the composite oxide had a higher Rh concentration than an inner portion thereof.

<Specific Surface Area and Degree of Surface Dispersion of Rh>

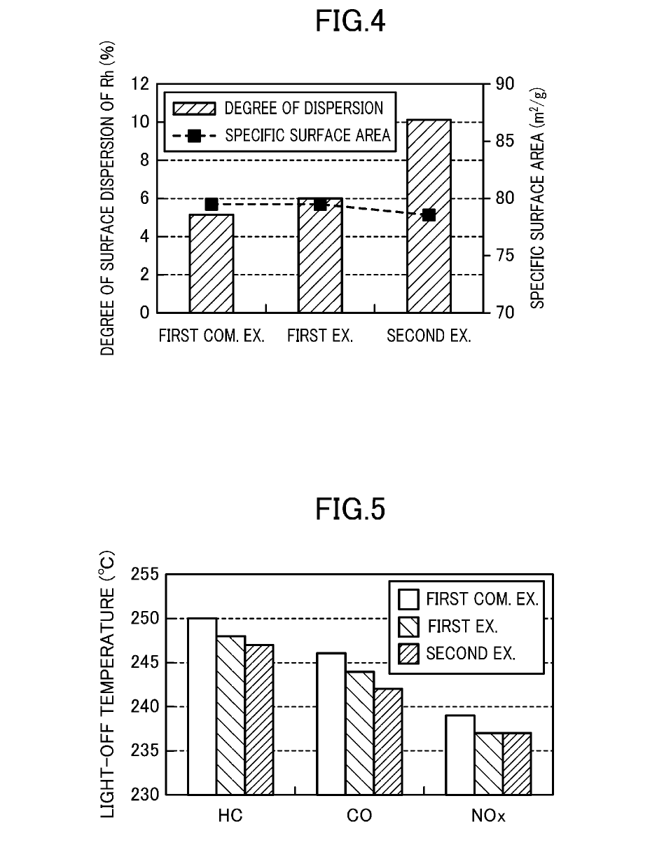

The specific surface area of the Rh-doped composite oxide of each of fresh samples of the first and second examples and the first comparative example was measured with an automated specific surface area/porosity analyzer (TriStar 3000 made by Micromeritics Instrument Corporation). In addition, the degree of dispersion of Rh on the surface of a composite oxide in each fresh sample was measured with an oxygen storage/release analyzer (made by AVC Co., LTD.) by CO-pulse oximetry. FIG. 4 shows these measurement results. Note that the degree of surface dispersion of Rh is the ratio of the amount of the metal Rh on the surface of a composite oxide derived from the amount of adsorbed CO, to the amount of added Rh calculated as a theoretical value from the amount of Rh prepared to form a sample. The measurement was conducted on the assumption that one CO atom is adsorbed on one Rh atom. In that case, a CO gas of which the number of moles was predetermined was introduced, as a pulse gas, into a sample at regular intervals, and the amount of adsorbed CO, which was obtained by measuring the amount of CO that was not adsorbed on this sample, was determined.

FIG. 4 shows that the differences in specific surface area between the first and second examples and the first comparative example are small. On the other hand, the degree of surface dispersion of Rh in each of the first and second examples is higher than that in the first comparative example. In particular, the degree of surface dispersion of Rh in the second example is very high. While, in the first example, 50% of the target amount of neodymium sulfate was added to the coprecipitated gel, the target amount of neodymium sulfate is entirely added to the coprecipitated gel in the second example. This may be why the degree of surface dispersion of Rh in the second example is higher than that in the first example.

<High-Temperature Durability Performance>

The catalysts of the first through third examples and the first comparative example were bench-aged. In this bench-aging, each catalyst was attached to an exhaust pipe of an engine, the engine rotational speed and engine load were set such that the catalyst bed temperature was 900° C., and the catalyst were exposed to an exhaust gas from the engine for 50 hours.

After the bench aging, a core sample having a support capacity of about 25 mL was cut out from each catalyst, and attached to a model gas flow reactor. Then, the temperature of a model gas flowing in the catalyst was gradually increased from room temperature, and changes in concentration of HC and CO contained in a gas flowing out of the catalyst was detected. Based on these detection results, the purification efficiencies and light-off temperatures for HC, CO, and NOx in each catalyst were determined. The light-off temperature is the gas temperature at a catalyst inlet when the purification efficiency for each component, i.e., HC, CO, or NOx, has reached 50%, and functions as an evaluation index of the low-temperature activity of a catalyst.

The model gas had an A/F ratio of 14.7±0.9. Specifically, a mainstream gas with an A/F ratio of 14.7 was allowed to constantly flow, and a predetermined amount of gas for changing the A/F ratio was added in pulses at a rate of 1 Hz, so that the A/F ratio was forcedly oscillated within the range of ±0.9. The space velocity SV was set at 60000/h⁻¹, and the rate of temperature increase was set at 30° C./min. Table 1 shows gas compositions at A/F=14.7, A/F=13.8, and A/F=15.6, respectively.

TABLE 1

| A/F | 13.8 | 14.7 | 15.6 |
|---|---|---|---|
| C₃H₆ (ppm) | 541 | 555 | 548 |
| CO (%) | 2.35 | 0.60 | 0.59 |
| NO (ppm) | 975 | 1000 | 980 |
| CO₂ (%) | 13.55 | 13.90 | 13.73 |
| H₂ (%) | 0.85 | 0.20 | 0.20 |
| O₂ (%) | 0.58 | 0.60 | 1.85 |
| H₂O (%) | 10 | 10 | 10 |
| N₂ | Remainder | Remainder | Remainder |

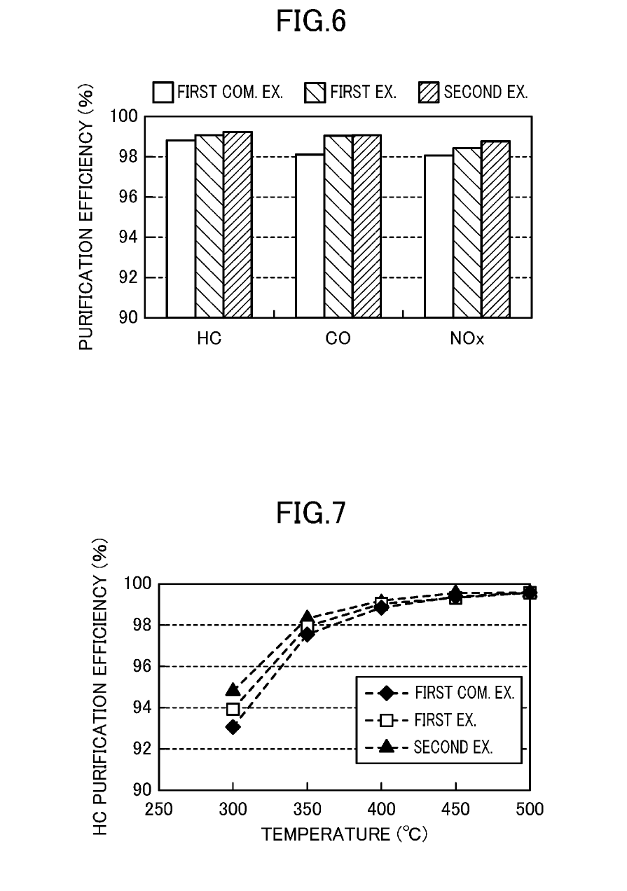

FIG. 5 shows the measurement results of the light-off temperatures of the first and second examples and the first comparative example. FIG. 6 shows the purification efficiencies for each component, i.e., HC, CO, or NOx, at the point of time when the catalyst inlet gas temperature reached 400° C.

FIGS. 5 and 6 indicate that the light-off temperature for any of HC, CO, and NOx in each of the first and second examples is lower than that in the first comparative example, and the purification efficiency therefor at 400° C. in each of the first and second examples is also higher than that in the first comparative example. FIG. 7 shows the relationship between the catalyst inlet gas temperatures and the HC purification efficiencies of the first and second examples and the first comparative example. FIG. 7 indicates that the HC purification efficiency in each of the first and second examples is higher than that in the first comparative example at catalyst inlet gas temperatures from 300° C. to 500° C.

The foregoing results show that increasing the Nd concentration in the surface portion of the composite oxide by adding part or the entirety of neodymium sulfate to the coprecipitated gel just like the first and second examples leads to an increase in the high-temperature durability of the catalyst. In addition, comparison between the first and second examples shows that with increasing Nd concentration in the surface portion of the composite oxide, the high-temperature durability of the catalyst increases.

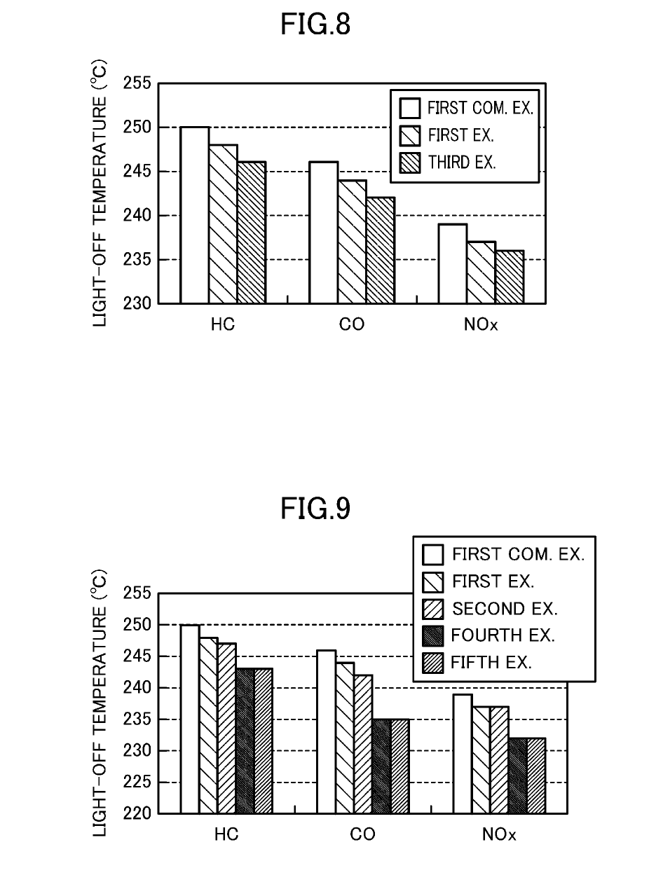

Next, FIG. 8 shows the light-off temperature of the third example and the light-off temperatures of the first example and the first comparative example. As previously described, in the third example, the amount of rhodium nitrate added to the coprecipitated gel was 80%, and the Rh concentration in the composite oxide surface portion was made higher than that in the first example. FIG. 8 shows that with increasing Rh concentration in the composite oxide surface portion, the low-temperature activity of the catalyst improves.

### Influence of Heating and Reducing Treatment

### Fourth Example

The Rh-doped composite oxide of the first example was subjected to a heating and reducing treatment in the presence of CO. Then, a honeycomb support similar to that in the first example was coated with this composite oxide in a similar manner, thereby obtaining a catalyst according to a fourth example. The amount of the Rh-doped composite oxide supported on the honeycomb support was 100 g/L just like the first example. In the heating and reducing treatment, the Rh-doped composite oxide was left in a reducing atmosphere having a CO concentration of 1% (the rest: N₂) and a temperature of 600° C. for 60 minutes. Note that a reducing atmosphere containing H₂ in place of CO may be employed.

### Fifth Example

After the Rh-doped composite oxide of the second example was subjected to a heating and reducing treatment similar to that in the fourth example, a honeycomb support similar to that in the first example was coated with the composite oxide in a similar manner, thereby obtaining a catalyst according to a fifth example. The amount of the Rh-doped composite oxide supported on the honeycomb support was 100 g/L just like the first example.

[Light-Off Temperature]

After the catalyst of each of the fourth and fifth examples was bench-aged in the process described in the section <High-Temperature Durability Performance>, the light-off temperatures for HC, CO, and NOx to be removed were measured. FIG. 9 shows the results together with those in the first and second examples and the first comparative example. The light-off temperature in each of the fourth and fifth examples is lower than that in an associated one of the first and second examples. This shows that the heating and reducing treatment improves the low-temperature activity of the catalyst.

### Second Embodiment

### Configuration of Exhaust Gas Purification Catalytic Material

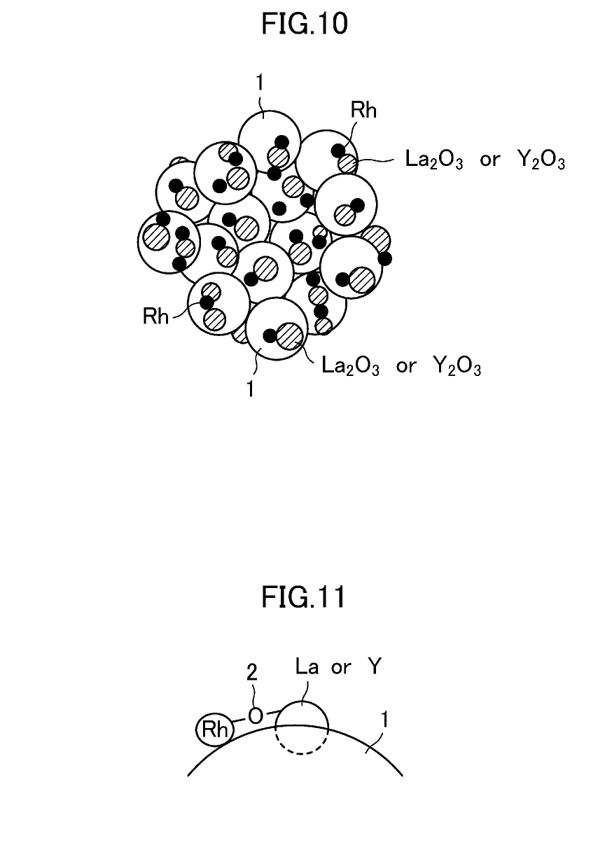

An exhaust gas purification catalytic material according to this embodiment is suitable for purifying an exhaust gas from an automobile, and is made of Rh-doped composite oxide particles 1 schematically shown in FIG. 10. These Rh-doped composite oxide particles 1 are obtained by doping, with Rh, a composite oxide that contains Zr, and at least La and Y as rare earth metals except Ce and is devoid of Ce. La and Y respectively exist in the form of La₂O₃ and Y₂O₃ forming part of the composite oxide, and a surface portion of each particle 1 has a higher La or Y concentration than an inner portion thereof. Specifically, at least part of La or Y is dissolved in the surface portion of the composite oxide, and a small amount of La or Y further exists, as an oxide, on the surface of the composite oxide, thereby allowing the particle surface portion to have a higher La or Y concentration than the particle inner portion. Rh is placed at crystal lattice points or between lattice points of the composite oxide, and is partially exposed at the surfaces of the particles 1. Thus, the surface portion of each particle 1 has a higher Rh concentration than the inner portion of the particle. As shown in FIG. 11, the Rh exposed at the surfaces of the particles 1 is firmly bonded, via oxygen 2, to La in La₂O₃ or Y in Y₂O₃ which exists in the surface portion and forms part of the composite oxide.

### Examples and Comparative Example of Exhaust Gas Purification Catalyst

### Sixth Example

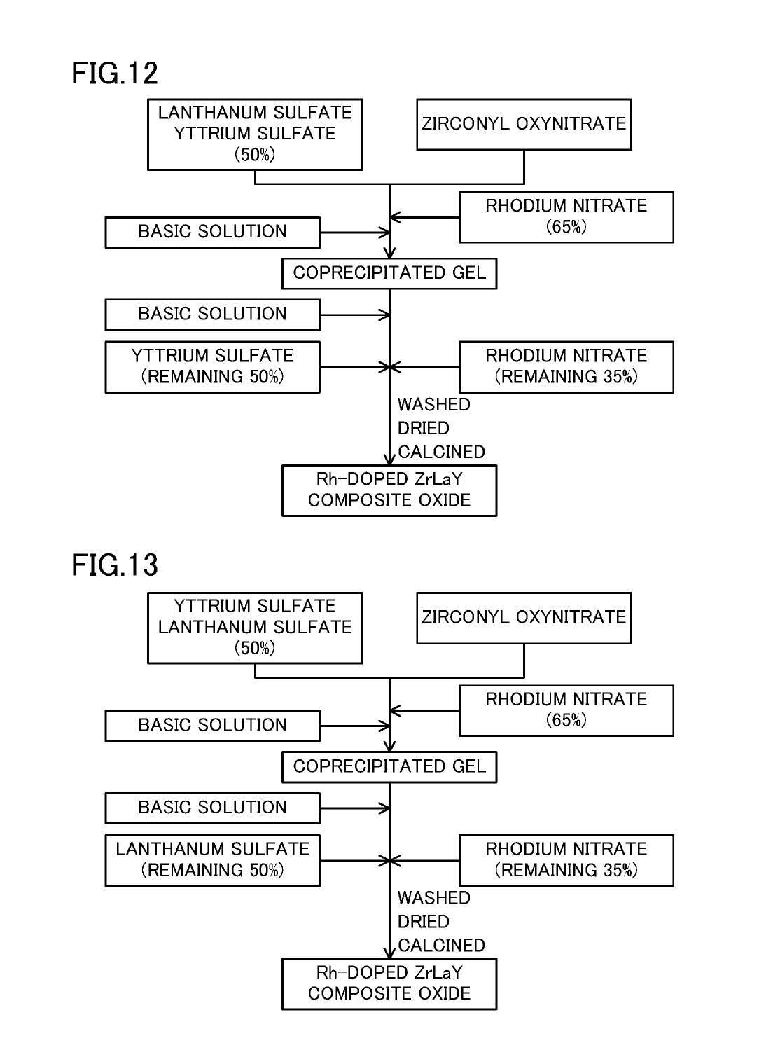

As shown in FIG. 12, an aqueous solution containing lanthanum sulfate and yttrium sulfate and an aqueous zirconyl oxynitrate solution were mixed, and an aqueous rhodium nitrate solution was further added to the mixture. The amount of the aqueous yttrium sulfate solution prepared in this stage was set to be 50% of the target amount of yttrium sulfate added (the total amount of the aqueous yttrium sulfate solution intended to form part of a Rh-doped composite oxide). The character “%” represents “% by mass.” This also applies to the rest of the description. In addition, the amount of the aqueous rhodium nitrate solution prepared in this stage was 65% of the target amount of rhodium nitrate added.

A basic solution (aqueous ammonia) was added to the resultant mixed solution (acid) of Zr, La, Y, and Rh, thereby coprecipitating Zr, La, Y, and Rh. A basic solution was added to the resultant RhZrLaY-containing coprecipitated gel so that the resultant mixture had a pH of about 11. Then, the remaining aqueous yttrium sulfate solution (50%) and the remaining aqueous rhodium nitrate solution (35%) were added to the mixture, and were mixed. In this manner, a Rh hydroxide and a Y hydroxide were precipitated on particles of the coprecipitated gel. A precipitate thus obtained was entirely washed and dried in the air at 150° C. for 24 hours. The dried precipitate was pulverized, and then calcined in the air at 520° C. for two hours. In this manner, a Rh-doped composite oxide (a Rh-doped ZrLaY composite oxide) that is a target substance was obtained.

The composition of the Rh-doped composite oxide except Rh is ZrO₂:La₂O₃:Y₂O₃=84:6:10 (mass ratio). The total Rh-doping amount is 1% by mass of the ZrLaY composite oxide.

The method for preparing the Rh-doped composite oxide is characterized in that the amounts of yttrium sulfate and rhodium nitrate prepared for coprecipitation were respectively 50% and 65%, and the remaining yttrium sulfate and the remaining rhodium nitrate were added to the coprecipitated gel.

Since part of yttrium sulfate (50%) was added to the coprecipitated gel, a surface portion of the resultant Rh-doped composite oxide had a higher Y concentration than an inner portion thereof. Since part of rhodium nitrate (35%) was added to the coprecipitated gel, the surface portion of the resultant Rh-doped composite oxide had a higher Rh concentration than the inner portion thereof.

Then, the Rh-doped composite oxide was mixed with a binder and water to form slurry, with which a honeycomb support was coated. The coated honeycomb support was calcined in the air at 500° C. for two hours, thereby obtaining a catalyst according to a sixth example. As the support, a honeycomb support similar to that in the first example was employed. The amount of the Rh-doped composite oxide supported per 1 L of the support was 100 g.

### Seventh Example

As shown in FIG. 13, the preparation of lanthanum sulfate and yttrium sulfate in the seventh example is different from that in the sixth example. Specifically, while the amount of lanthanum sulfate prepared for coprecipitation was 50%, the amount of yttrium sulfate prepared was equal to the total target amount of yttrium sulfate added (100%). In this manner, a RhZrLaY-containing coprecipitated gel was obtained. Then, the remaining lanthanum sulfate (50%) was added to this coprecipitated gel. Just like the sixth example, the amount of rhodium nitrate prepared for coprecipitation was 65% of the target amount of rhodium nitrate added, and the remaining rhodium nitrate (35%) was added to the coprecipitated gel. Then, as for the rest, a Rh-doped composite oxide that is a target substance was obtained in a manner similar to that in the sixth example. The composition of the resultant Rh-doped composite oxide except Rh and the Rh-doping amount were the same as those of the sixth example. A honeycomb support similar to that in the sixth example was coated with this Rh-doped composite oxide in a similar manner, thereby obtaining a catalyst according to a seventh example. The amount of the Rh-doped composite oxide supported on the honeycomb support was 100 g/L just like the sixth example.

Since, in the seventh example, part of lanthanum sulfate (50%) was added to the coprecipitated gel, a surface portion of the resultant Rh-doped composite oxide had a higher La concentration than an inner portion thereof. The surface portion of the resultant Rh-doped composite oxide had a higher Rh concentration than the inner portion thereof just like the sixth example.

### Eighth Example

The preparation of rhodium nitrate in the eighth example is different from that in the sixth example. Specifically, just like the sixth example, the amount of yttrium sulfate prepared for coprecipitation was 50%, and the remaining yttrium sulfate (50%) was added to a coprecipitated gel. However, unlike the sixth example, the amount of rhodium nitrate prepared for coprecipitation was 20%, and the remaining rhodium nitrate (80%) was added to the coprecipitated gel. Then, as for the rest, a Rh-doped ZrLaY composite oxide that is a target substance was obtained in a manner similar to that in the sixth example. The composition of the Rh-doped composite oxide except Rh and the Rh-doping amount were the same as those of the sixth example. A honeycomb support similar to that in the sixth example was coated with this Rh-doped composite oxide in a similar manner, thereby obtaining a catalyst according to an eighth example. The amount of the Rh-doped composite oxide supported on the honeycomb support was 100 g/L just like the sixth example.

Also in the eighth example, a surface portion of the resultant Rh-doped composite oxide had a higher Y concentration and a higher Rh concentration than an inner portion thereof just like the sixth example.

### Ninth Example

The preparation of rhodium nitrate in the ninth example is different from that in the seventh example. Specifically, just like the seventh example, the amount of lanthanum sulfate prepared for coprecipitation was 50%, and the remaining lanthanum sulfate (50%) was added to a coprecipitated gel. However, unlike the seventh example, the amount of rhodium nitrate prepared for coprecipitation was 20%, and the remaining rhodium nitrate (80%) was added to the coprecipitated gel. Then, as for the rest, a Rh-doped ZrLaY composite oxide that is a target substance was obtained in a manner similar to that in the seventh example. The composition of the Rh-doped composite oxide except Rh and the Rh-doping amount were the same as those of the sixth example. A honeycomb support similar to that in the sixth example was coated with this Rh-doped composite oxide in a similar manner to obtain a catalyst according to a ninth example. The amount of the Rh-doped composite oxide supported on the honeycomb support was 100 g/L just like the sixth example.

Also in the ninth example, a surface portion of the resultant Rh-doped composite oxide had a higher La concentration and a higher Rh concentration than an inner portion thereof just like the seventh example.

### Second Comparative Example

Target amounts of both lanthanum sulfate and yttrium sulfate added were entirely prepared for coprecipitation, and the amounts of lanthanum sulfate and yttrium sulfate added to a coprecipitated gel was zero. Just like the sixth example, the amount of rhodium nitrate prepared for coprecipitation was 65% of the target amount of rhodium nitrate added, and the remaining rhodium nitrate (35%) was added to the coprecipitated gel. Then, as for the rest, a Rh-doped ZrLaY composite oxide that is a target substance was obtained in a manner similar to that in the sixth example. The composition of the resultant Rh-doped composite oxide except Rh and the Rh-doping amount were the same as those of the sixth example. A honeycomb support similar to that in the sixth example was coated with this Rh-doped composite oxide in a similar manner, thereby obtaining a catalyst according to a second comparative example. The amount of the Rh-doped composite oxide supported on the honeycomb support was 100 g/L just like the sixth example.

Since, in the second comparative example, target amounts of lanthanum sulfate and yttrium sulfate were entirely prepared for coprecipitation, it was recognized that the La and Y concentrations in the resultant Rh-doped composite oxide were substantially uniform all over the composite oxide. Just like the sixth example, a surface portion of the composite oxide had a higher Rh concentration than an inner portion thereof.

<High-Temperature Durability Performance>

After the catalyst of each of the sixth through ninth examples and the second comparative example was bench-aged in the process described in the section <High-Temperature Durability Performance> of the first embodiment, the purification efficiencies and light-off temperatures for HC, CO, and NOx were determined in a similar manner

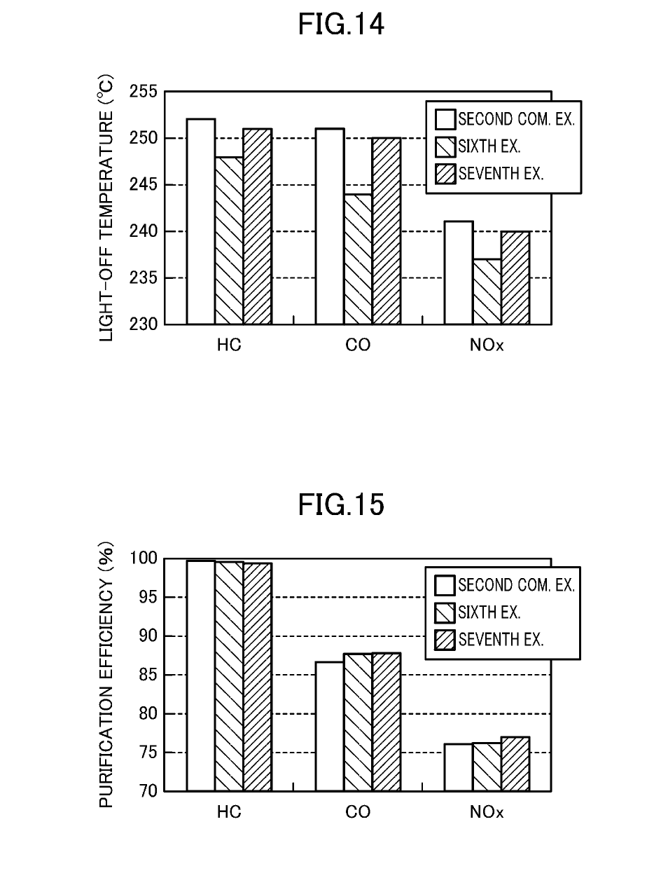

FIG. 14 shows the measurement results of the light-off temperatures of the sixth and seventh examples and the second comparative example. FIG. 15 shows the purification efficiency for each component, i.e., HC, CO, or NOx, at the point of time when the catalyst inlet gas temperature reached 400° C.

FIG. 14 indicates that the light-off temperature for any of HC, CO, and NOx in each of the sixth and seventh examples is lower than that in the second comparative example. FIG. 15 indicates that while the purification efficiency for HC at 400° C. in each of the sixth and seventh examples is substantially equivalent to that in the second comparative example, the purification efficiencies for CO and NOx at 400° C. in each of the sixth and seventh examples are higher than those in the second comparative example. The foregoing results show that increasing the La or Y concentration in the surface portion of the composite oxide by adding part of lanthanum sulfate or yttrium sulfate to the coprecipitated gel just like the sixth and seventh examples leads to an increase in the high-temperature durability and light-off performance of the catalyst.

In addition, comparison between the sixth and seventh examples shows that an increase in Y concentration in the surface portion of the composite oxide decreases the light-off temperature, and in other words, helps improve the low-temperature activity of the catalyst, and an increase in La concentration in the surface portion of the composite oxide helps improve the high-temperature activity of the catalyst.

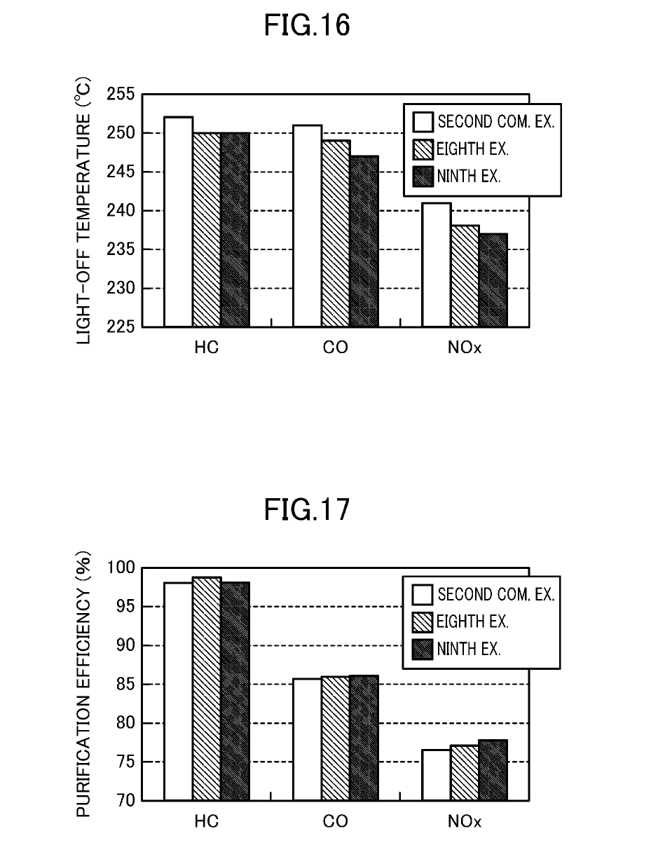

FIG. 16 shows the measurement results of the light-off temperatures of the eighth and ninth examples and the second comparative example. FIG. 17 shows the purification efficiency for each component, i.e., HC, CO, or NOx, at the point of time when the catalyst inlet gas temperature reached 400° C.

FIGS. 16 and 17 indicate that the light-off temperature for any of HC, CO, and NOx in each of the eighth and ninth examples is lower than that in the second comparative example, the purification efficiency therefor at 400° C. in each of the eighth and ninth examples is also higher than that in the second comparative example, and also if the Rh concentration in the composite oxide surface portion is increased by increasing the amount of rhodium nitrate added to the coprecipitated gel, the high-temperature durability increases just like the sixth and seventh examples.

### Influence of Heating and Reducing Treatment

### Tenth Example

The Rh-doped composite oxide of the sixth example was subjected to the same heating and reducing treatment in the presence of CO as in the fourth and fifth examples of the first embodiment. Then, a honeycomb support similar to that in the sixth example is coated with this composite oxide in a similar manner, thereby obtaining a catalyst according to a tenth example. The amount of the Rh-doped composite oxide supported on the honeycomb support was 100 g/L just like the sixth example.

### Eleventh Example

The Rh-doped composite oxide of the seventh example was subjected to a heating and reducing treatment similar to that in the tenth example. Then, a honeycomb support similar to that in the sixth example is coated with this composite oxide in a similar manner, thereby obtaining a catalyst according to an eleventh example. The amount of the Rh-doped composite oxide supported on the honeycomb support was 100 g/L just like the sixth example.

[NOx Purification Performance]

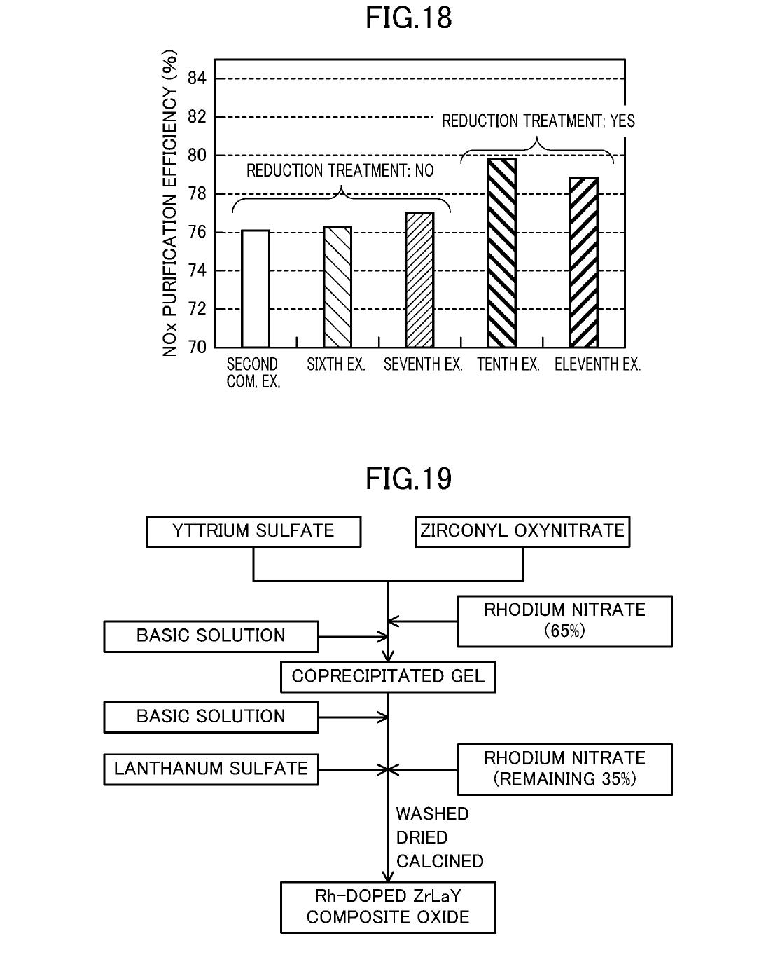

After the catalyst of each of the tenth and eleventh examples was bench-aged in the process described in the section <High-Temperature Durability Performance> of the first embodiment, the purification efficiency for NOx at a catalyst inlet gas temperature of 400° C. was measured in a similar manner FIG. 18 shows the results together with those in the sixth and seventh examples and the second comparative example that have been described above. The purification efficiency for NOx in each of the tenth and eleventh examples is higher than that in an associated one of the sixth and seventh examples. This shows that the heating and reducing treatment improves the purification performance of the catalyst for NOx.

### Twelfth Example

As shown in FIG. 19, while the amount of yttrium sulfate prepared for coprecipitation was equal to the total target amount of yttrium sulfate added (100%), the amount of lanthanum sulfate prepared for coprecipitation was zero. Thus, a RhZrY-containing coprecipitated gel was obtained. Then, a target amount of lanthanum sulfate (100%) was entirely added to this coprecipitated gel. Just like the sixth example, the amount of rhodium nitrate prepared for coprecipitation was 65% of the target amount of rhodium nitrate added, and the remaining rhodium nitrate (35%) was added to the coprecipitated gel. Then, as for the rest, a Rh-doped composite oxide that is a target substance was obtained in a manner similar to that in the sixth example. The composition of the resultant Rh-doped composite oxide except Rh and the Rh-doping amount were the same as those of the sixth example. After this Rh-doped composite oxide was subjected to a heating and reducing treatment similar to that in the tenth example, a honeycomb support similar to that in the sixth example was coated with this Rh-doped composite oxide in a similar manner, thereby obtaining a catalyst according to a twelfth example. The amount of the Rh-doped composite oxide supported on the honeycomb support was 100 g/L just like the sixth example.

Since, in the twelfth example, a target amount of lanthanum sulfate was entirely added to the coprecipitated gel, a surface portion of the resultant Rh-doped composite oxide had a high La concentration, and an inner portion thereof was substantially devoid of La. The surface portion of the composite oxide had a higher Rh concentration than the inner portion thereof just like the sixth example.

[Light-Off Temperature]

After the catalyst of the twelfth example was bench-aged in the process described in the section <High-Temperature Durability Performance> of the first embodiment, the light-off temperatures for HC, CO, and NOx to be removed were measured in a similar manner Table 2 shows the results together with those in the second comparative example that has been described above.

TABLE 2

LIGHT-OFF TEMPERATURE (° C.)

| | HC | CO | NOx |
|---|---|---|---|
| TWELFTH EX. | 251 | 249 | 240 |
| SECOND COM. EX. | 252 | 251 | 241 |

This shows that in the twelfth example, the light-off temperatures for HC, CO, and NOx are all lower than those in the second comparative example, and the high-temperature durability of the catalyst is improved.

### DESCRIPTION OF REFERENCE CHARACTERS

1 Rh-doped Composite Oxide Particle
2 Oxygen

1-5. (canceled)

6. An exhaust gas purification catalytic material made of a composite oxide containing Zr and a plurality of rare earth metals and doped with Rh, wherein
the composite oxide contains at least La and Y as the rare earth metals, and is devoid of Ce, and
the surface portion of the composite oxide has a higher concentration of at least one of the La or the Y than the inner portion of the composite oxide.

7. The exhaust gas purification catalytic material of claim 6, wherein
the composite oxide has been subjected to a heating reduction treatment.

8. A method for producing an exhaust gas purification catalytic material made of a composite oxide containing Zr, and at least Ce and Nd as rare earth metals and doped with Rh, a surface portion of the composite oxide having a higher concentration of the Nd than an inner portion of the composite oxide, the method comprising steps of:
coprecipitating Ce, Zr, and Rh by adding a basic solution to an acidic solution containing Ce ions, Zr ions, and Rh ions;
adding a basic solution to a RhCeZr-containing coprecipitated gel formed by the coprecipitation;
adding an acidic solution containing Rh ions and Nd ions to the RhCeZr-containing coprecipitated gel to which the basic solution has been added, and mixing them; and
calcining a precursor which is the RhCeZr-containing coprecipitated gel having a Rh hydroxide and a Nd hydroxide precipitated thereon through the mixing.

9. The method of claim 8 further comprising a step of:
heating the calcined precursor in a reducing atmosphere after the calcination.

10. A method for producing the exhaust gas purification catalytic material of claim 6, the method comprising steps of:
coprecipitating Zr, La, Y, and Rh by adding a basic solution to an acidic solution that contains Zr ions, La ions, Y ions, and Rh ions and is devoid of Ce;
adding a basic solution to a RhZrLaY-containing coprecipitated gel formed by the coprecipitation;
adding an acidic solution containing La or Y ions and Rh ions to the RhZrLaY-containing coprecipitated gel to which the basic solution has been added, and mixing them; and
calcining a precursor which is the RhZrLaY-containing coprecipitated gel having a La or Y hydroxide and a Rh hydroxide precipitated thereon through the mixing.

11. The method of claim 10 further comprising a step of:
heating the calcined precursor in a reducing atmosphere after the calcination.
